(19) United States
(12) Patent Application Publication
(10) Pub. No.: US 2010/0239735 A1
(43) Pub. Date: Sep. 23, 2010

(54) Adjustable food mold and method

(76) Inventor: Rodney Robbins, Florence, AL (US)

Correspondence Address: Gregor N. Neff, 14th Floor, 489 5th Avenue, New York, NY, 10017, US

(21) Appl. No.: 12/383,114

(22) Filed: Mar. 18, 2009

(51) Int. Cl. A22C 7/00; A23P 1/10

(52) U.S. Cl. 426/513; 425/150; 426/512

(57) ABSTRACT

Adjustable mold with a cylindrical sidewall-forming structure and a food support member slidably attached to the sidewall-forming structure to provide an adjustable molding space. Preferably, one or more stop members is provided on one of the parts, together with a lock structure on the other of the parts. By means of the lock structure, the stop members can be positioned at a variable distance from the food support surface while providing solid horizontal support surfaces to support the stop members and hold the sidewall-forming structure securely in place.

This invention relates to food molds and methods, and particularly to adjustable food molds and methods.

Some prior molds used to make hamburgers or other ground meat patties, crabcakes or the like, are relatively difficult to use and sometimes are deficient in providing patties or other molded food objects of a consistent thickness.

Other prior molding devices tend to be difficult to clean, overly expensive to make and have other defects or shortcomings which require improvement.

Accordingly, it is an object of the present invention to provide an adjustable food mold and method of use which overcome or alleviate the foregoing problems.

In particular, it is an object of the invention to provide an adjustable food mold from which it is relatively simple and quick to remove the molded food item.

It is also the object of the invention to provide such a device and method of using it in which one of a number of different thicknesses for the molded food article can be selected and maintained relatively accurately from one molding operation to the next.

It is a further object of the invention to provide a relatively simple, easy to clean, and inexpensive to manufacture device which meets the other objectives set forth above.

In accordance with the present invention, there is provided an upstanding vertical food support structure which forms a food support surface, with a sidewall-forming structure encircling the food support member and sliding upwardly and downwardly thereon to provide an adjustable molding space.

Preferably, one or more stop members is provided in one of the two parts. A lock structure is provided on the other of the two parts. By means of the lock structure, the stop members can be positioned at a variable distance from the food support surface while providing solid horizontal support surfaces to support the stop members and hold the sidewall-forming structure securely in place.

Also preferably, the food support member and sidewall-forming structure are cylindrical with the food support member sitting inside of the side-wall forming structure.

Preferably, the lock structures are positioned on the food support member and include a vertical groove with a plurality of horizontal branches extending from the groove and providing horizontal support surfaces at varying distances from the food support surface.

It is also preferable that a plurality of the stop members and lock structures are provided around the circumference of the device so as to provide multiple support points to hold the mold in a stable shape, even under the high pressure applied by pressing downwardly on a food mass in the mold to form it into the desirable shape, thus better enabling the user to maintain a relatively constant thickness for the patties.

Advantageously, the molded food mass can be easily ejected from the mold merely by sliding the sidewall-forming structure downwardly on the food support member, thereby effectively ejecting the item from the mold.

Other objects and advantages of the invention will be set forth and/or apparent from the following description and drawings.

### IN THE DRAWINGS

FIG. 1 is a top plan view of an adjustable food mold constructed in accordance with the present invention;

FIG. 2 is a front perspective view of the device shown in FIG. 1;

FIG. 3 is a front elevation view of the device shown in FIG. 1;

FIG. 4 is a bottom plan view of the structure shown in FIGS. 1-3; and

FIG. 5 is an exploded front perspective view of the two components of the adjustable food mold shown in FIGS. 1-4.

### ADJUSTABLE MOLD

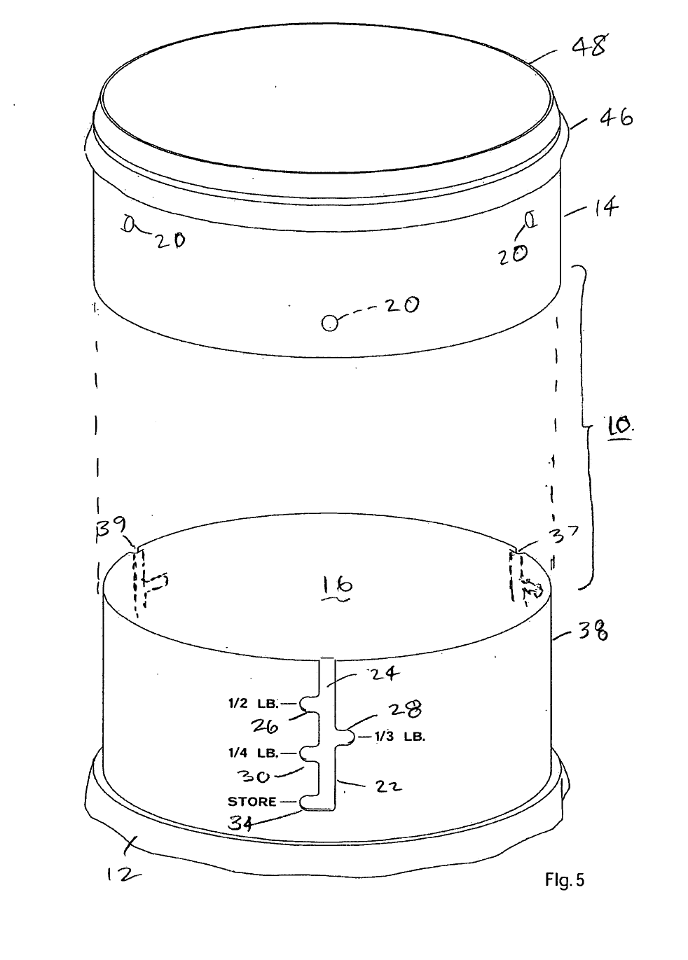

As it is apparent from FIG. 5, an embodiment of the adjustable food mold 10 of the present invention consists of a lower food support member 38 extending upwardly from a base portion 12 which rests on a horizontal surface when the mold is in use.

The food support member 38 is cylindrical in shape with a horizontal upper surface 16 of circular shape. An upper ring-shaped cylindrical portion 14 is provided to slide downwardly over the outer surface of the member 38 with the inner surface of the cylindrical ring 14 in contact with the outer surface of the member 38 so that the two parts slide with respect one another relatively easily.

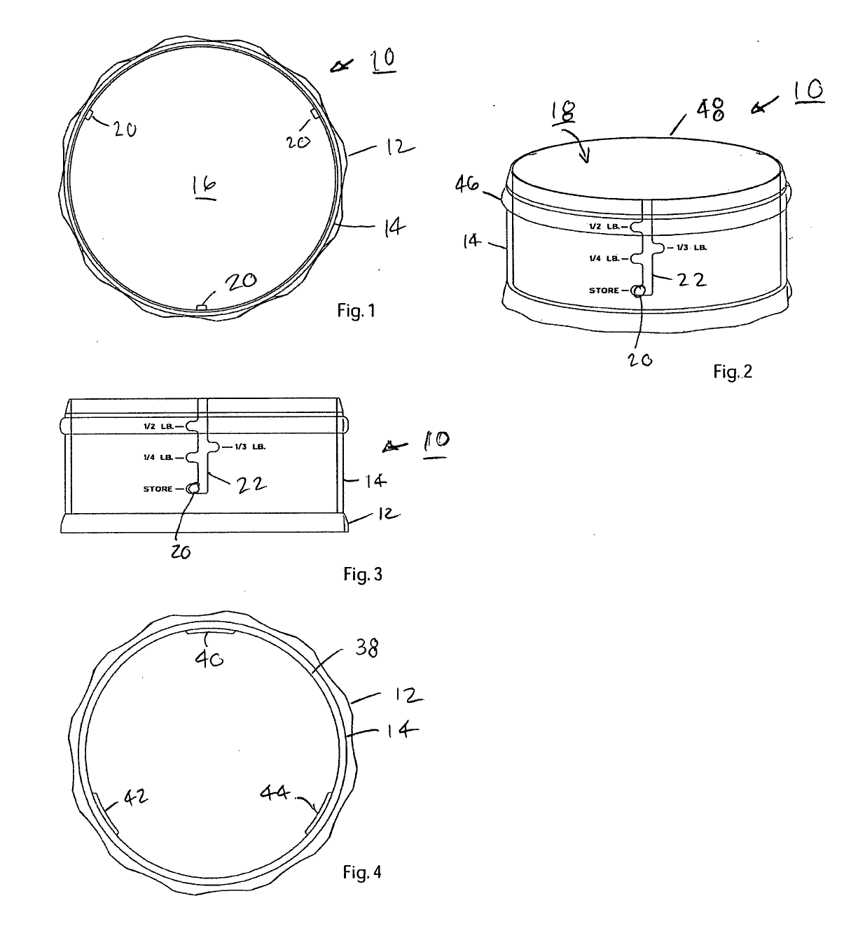

As it is shown in FIGS. 1 and 5, 3 projections 20 extend inwardly from the inner surface of the ring 14. Each of the projections 20 is located at the same height above the bottom edge of the ring 14, and each is spaced circumferentially from the other by equal distances; that is, the projections 20 are located at an angle of 120° from one another.

Referring now to FIG. 5, the food support member 38 has three vertical grooves, 24, 37 and 39 forming a part of three locking structures 22 for receiving the projections 20 and locking them in one of several selected horizontal positions. The locking structures also are located at angles of 120° from one another.

The vertical grooves 37 and 39 are identical to the groove 24. Each groove has a plurality of horizontal branches or extensions such as 26, 28, 30 and 34, each of which provides a solid horizontal edge to support the projection 20 and the ring 14.

The ring 14 has an outwardly extending bead or flange 46 for reinforcement.

FIG. 4, the bottom plan view of the food support member 38, shows that it is a hollow cylinder with bulging areas 42, 40 and 44 which are formed to provide thickened material to support the grooves 24, 37 and 39 and the other parts of the locking structures.

The ring 14 and the food support member 38 are shown in FIGS. 2 and 3 in the “store” position; that is with the projections 20 positioned in the bottom horizontal branch of the locking structure to give the combined structure a minimum height for economical use of space when the device is stored.

### Method of Use

When it is desired to make hamburger patties (or other similarly-shaped food objects), the ring 14 is turned clockwise relative to the base 12 to move the projections 20 out of the “store” slot 34, the ring 14 is lifted upwardly until the projections 20 reach one of the other horizontal branches, and the ring 14 is rotated to move the projections 20 into the branches. This provides a receptacle, indicated generally at 18 in FIG. 2, for receiving the food to be molded.

Each of the horizontal branches of the locking structure is provided with a marking indicating the weight of the hamburger patties, which will be produced by the use of that setting. Thus, locating the projections 20 in the slot 30 will produce a ¼ pound patty; the slot 26 will provide a ½ pound patty, etc.

When the ring 14 has been moved to the proper position, the food material is placed in the receptacle 18 and pressed downwardly, either by using the hand or an object having a flat surface.

One of the advantages of the invention is that the three horizontal surfaces supporting the three projections 20 hold the ring 14 firmly against downward pressure applied by the hand or other object to the food being molded.

When the molded food object has been formed, it can be removed from the mold simply by rotating the ring 14 to disengage the projections 20 from the horizontal slots, and pressing downwardly on the ring until it slides to the bottom of the slots 24, 37 and 39. This, in effect pushes the molded food item out of the mold quickly and easily.

The two parts of the adjustable food mold can be easily separated from one another and washed by hand or in a dishwasher, if desired.

Preferably, the components of the device are molded out of thermoplastic materials. Preferably, the ring 14 is made transparent and the food support member 38 is made of substantially less transparent preferably opaque, material.

When it is desired to store the food mold when not in use, it is convenient to return the projections 20 to the “store” slot 34 to make the device compact for storage.

The above description of the invention is intended to be illustrative and not limiting. Various changes or modifications in the embodiments described may occur to those skilled in the art. These can be made without departing from the spirit or scope of the invention.

What is claimed is:

1. An adjustable food mold comprising
a. A base structure having a base portion and a food support member extending upwardly from said base portion and forming an upper food support surface,
b. A sidewall forming structure, said sidewall forming structure having at least one sidewall shaped to conform to the shape of the outside of said food support member with said one sidewall enveloping and contacting said outside of said food support support member.
c. Said sidewall forming structure being movable upwardly and downwardly along said food support member with a portion of said sidewall extending above said upper food support surface to form a food mold of variable depth,
d. A stop member comprising a projection extending from a side surface of one of said food support member and said sidewall forming structure, and
e. A mating lock structure on the other of said food support member and said sidewall forming structure,
f. Said lock structure being positioned to receive said projection and forming a plurality of solid horizontal surfaces at varying vertical distances from said upper food support surface whereby said sidewall forming structure can be solidly supported at a variable height above said upper food support surface.

2. A device as in claim 1, in which said lock structure comprises at least one vertical groove dimensioned to receive said projection and allow said projection to move vertically in said groove, and a plurality of horizontal grooves branching off from said vertical groove, each of said horizontal grooves forming one of said solid horizontal surfaces and being dimensioned to receive said projection therein and tend to hold said sidewall forming structure in a predetermined position against downward pressure applied to a food mass within said sidewall forming structure.

3. A device as in claim 1 in which both said food support member and said sidewall forming structure are approximately cylindrical in shape, and said projection extends from the inside of the sidewall formed by said sidewall forming structure, and said lock structure is formed in the outside surface of said food support member.

4. A device as in claim 1 including a plurality of said projections spaced circumferentially from one another and extending from the inside of the sidewall formed by said sidewall forming structure, and a plurality of vertical grooves in the outside surface of said food support member, said grooves being dimensioned to receive said projections to allow vertical movement therein, said grooves having the same spacing from one another as said projections are spaced from one another, and at least one of said grooves having a plurality of horizontal branches for receiving and supporting any one of said projections.

5. A device as in claim 4 in which each of said grooves has said plurality of horizontal branches.

6. A device as in claim 1 including a plurality of said stop members spaced circumferentially from one another with a predetermined spacing, and a plurality of said lock structures, one for each of said stop members, said lock structures being spaced circumferentially from one another with the same spacing as said stop members.

7. A device as in claim 1 in which said sidewall forming structure is made of a first transparent material and said food support member is made of a second material substantially less transparent than said first material.

8. A method of molding a pliable food mass into a desirable shape, said method comprising the steps of:
a. Providing an adjustable food mold comprising
i. A base structure having a base portion and a food support member extending upwardly from said base portion and forming an upper food support surface,
ii. A sidewall forming structure, said sidewall forming structure having at least one sidewall shaped to conform to the shape of the outside of said food support member with said one sidewall enveloping and contacting said outside of said food support support member.
iii. Said sidewall forming structure being movable upwardly and downwardly along said food support member with a portion of said sidewall extending above said upper food support surface to form a food mold of variable depth,
iv. A stop member comprising a projection extending from a side surface of one of said food support member and said sidewall forming structure, and
v. A mating lock structure on the other of said food support member and said sidewall forming structure,
vi. Said lock structure being positioned to receive said projection and forming a plurality of solid horizontal surfaces at varying vertical distances from said upper food support surface whereby said sidewall forming structure can be solidly supported at a variable height above said upper food support surface.
b. Setting said sidewall forming structure at a selected height relative to said upper food support surface,
c. Placing said food mass in the receptacle formed by said upper food support surface and said sidewall forming structure, and
d. Pressing downwardly on said food mass to give it the shape of said receptacle.

9. A method as in claim 8 in which both said food support member and said sidewall forming structure are approximately cylindrical in shape, and said projection extends from the inside of the sidewall formed by said sidewall forming structure, and said lock structure is formed in the outside surface of said food support member. Said food mass comprising a mixture including ground meat or seafood.

10. A method as in claim 9 including a plurality of said projections spaced circumferentially from one another and extending from the inside of the sidewall formed by said sidewall forming structure, and a plurality of vertical grooves in the outside surface of said food support member, said grooves being dimensioned to receive said projections to allow vertical movement therein, said grooves having the same spacing from one another as said projections are spaced from one another, and at least one of said grooves having a plurality of horizontal branches for receiving and supporting any one of said projections.
